(19) United States
(12) Patent Application Publication
(10) Pub. No.: US 2017/0056293 A1
(43) Pub. Date: Mar. 2, 2017

(54) Syringe-Type Baby Feeder

(71) Applicant: Aaron Marshall Taylor, Granada Hill, CA (US)

(72) Inventor: Aaron Marshall Taylor, Granada Hill, CA (US)

(21) Appl. No.: 15/244,691

(22) Filed: Aug. 23, 2016

Related U.S. Application Data
(60) Provisional application No. 62/209,062, filed on Aug. 24, 2015.

(51) Int. Cl. A61J 7/00

(52) U.S. Cl. CPC A61J 7/0053

(57) ABSTRACT

A syringe-type baby feeder having a barrel and plunger mechanism and finger rings on the barrel and plunger to allow for one-handed feeding of an infant. A nipple portion is hermetically sealed to end of the plunger to allow for easy feeding, as well as easy attachment and removal of the nipple portion to the plunger.

### CROSS REFERENCE TO RELATED APPLICATION

This application claims priority to U.S. Provisional Application No. 62/209,062, filed Aug. 24, 2015, which is hereby incorporated by reference in its entirety as if fully recited herein.

### BACKGROUND OF THE INVENTION

Infants are typically fed pureed foods with a spoon by his/her caregiver or parent before moving on to solid food. Spoon-feeding, however, often results in much of the baby food over the infant's face and clothes and not in his/her mouth.

Attempts to address this problem have included use of a spoon with a hollow core to feed baby food at a more controlled rate, a mesh bag that allows the baby to chew on solid food without the risk of choking, and a squeezable bottle with a spoon attachment for easy feeding. However, each of these solutions has its own apparent drawbacks. The present invention allows for easy feeding of a baby without the drawbacks presented by the aforementioned products.

### SUMMARY OF THE INVENTION

A syringe-style baby feeder is generally disclosed. The syringe-style baby feeder allows a user to feed the infant with a single hand, allowing the other hand to remain available for other uses. Once the baby feeder is assembled, baby food can be drawn though the attached nipple piece via the barrel (or cylinder) and plunger (or pusher) mechanism and then squirted into the mouth of the baby. The nipple piece is attached to the barrel via a hermetic seal, which allows for easy replacement of the nipple piece and also use of a variety of nipple pieces.

In one embodiment, a syringe-type baby feeder comprises a barrel having a seal at one end thereof and two opposing finger rings provided on an outside of the barrel; a plunger sized to fit within the barrel; the plunger having a pusher portion at one end thereof to move baby food along the barrel; the plunger having a finger ring formed at the other end thereof; a nipple piece having a nipple, flange portion and a seal formed between the nipple and the flange portion; and the seal formed between the nipple and flange portion hermetically sealing to the seal at the one end of the barrel.

### BRIEF DESCRIPTION OF THE DRAWINGS

A more complete understanding of the present invention may be obtained with reference to the Detailed Description when taken in conjunction with the accompanying Drawings.

FIG. 1 is an exploded view of the syringe-type baby feeder in accordance with one aspect of the present invention; and

FIG. 2 is an assembled view of a syringe-type baby feeder of FIG. 1.

### DETAILED DESCRIPTION OF THE INVENTION

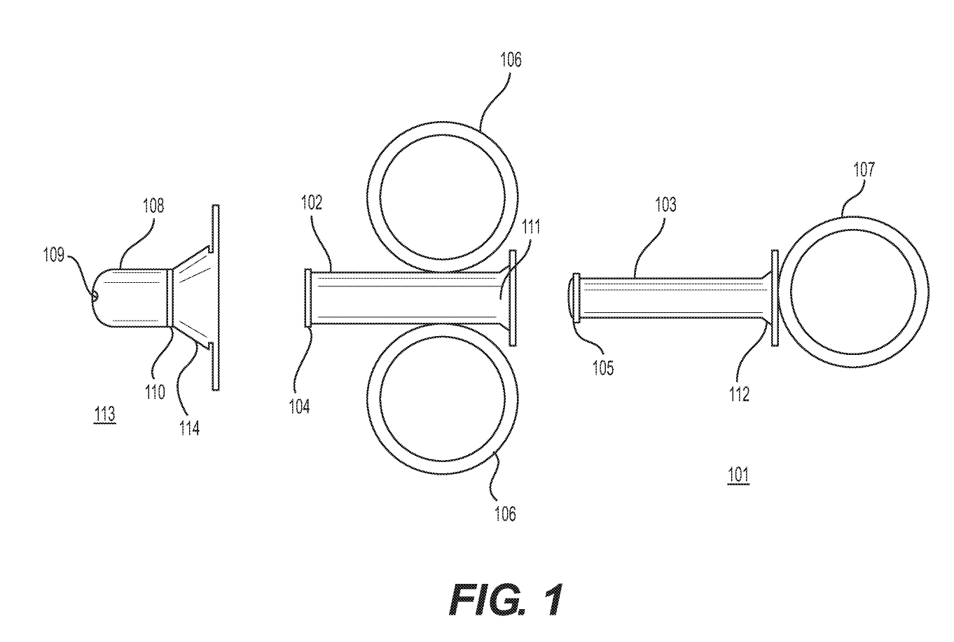

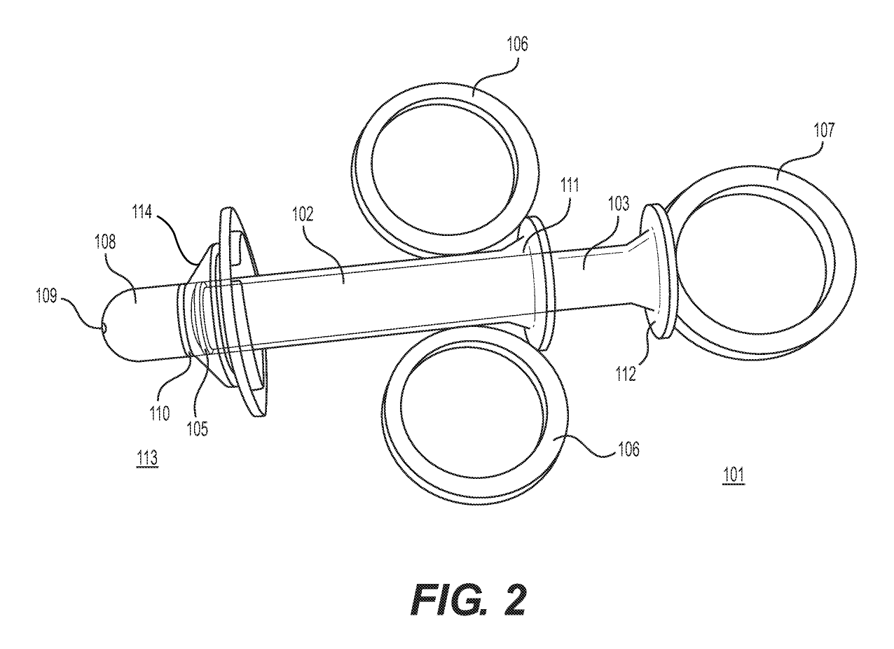

Referring now to FIGS. 1 and 2, baby feeder 101 is shown. Baby feeder 101 has a barrel 102 and plunger 103 mechanism. Barrel 102 is hollow and is open at both ends to allow for the plunger 103 and baby food to move there through. At one end of barrel 102 is a seal 104 formed around an edge of the one end of the barrel 102. At one end of plunger 103 is also a pusher 105. Pusher 105 can be rounded. Seal 104 can be a variety of widths, but preferably ⅛ inch. Plunger 103 is sized such that plunger 103 can fit within and slide along barrel 102 and push baby food along barrel 102 via pusher 105.

Barrel 102 has opposing finger rings 106 on an outside surface of barrel 102. Opposing finger rings 106 can be grasped by a user to allow a user to easily grip the feeder 101 and to allow for one-handed use. In one embodiment, opposing finger rings 106 are circular. Plunger 103 also has a finger ring 107, which can also be grasped by a user during one-handed use. In one embodiment, finger ring 107 is also circular. These finger rings 106 and 107 can be a variety of sizes, but preferably circular, with a ¾ inch in diameter. These finger rings 106 and 107 can be grasped by the middle and index fingers and thumb of a user.

Attached to the one end of barrel 102 having seal 104 is nipple piece 113. Nipple piece 113 generally comprises three parts: a nipple 108, a flanged portion 114 and a seal 110 formed between the nipple 108 and flanged portion 114. An opening 109 is provided at one end of nipple 108 to allow for food to pass in and out of the baby feeder. The size of opening 109 can be varied to allow for various rates of food to be dispensed. Seal 110 of nipple piece 113, abuts with seal 104 of barrel 102 when assembled. While other means to attach the nipple piece 113 to the barrel 102 are possible, such as a screw-type mean, use of seals 104 and 110 allows for a variety of nipple attachments to be used and interchanged.

At an opposite end of seal 104 on barrel 102 is a flanged opening 111, which allows for easy insertion of the plunger 103. Similarly, at an opposite end from seal 105 on plunger 103 is flanged portion 112 to correspond with flanged opening 111.

General directions for use of the syringe-type baby feeder are as follows:
1. Clean all components thoroughly before use.
2. Apply water to the inside of the nipple so that it slides over the lip/seal on the barrel/cylinder.
3. Slide the plunger/pusher inside the hollow cylinder.
4. Submerge the nipple portion into baby food and pull the plunger/pusher out of the barrel/cylinder portion, drawing the baby food in.
5. Carefully insert the nipple in the baby's mouth and slowly depress the plunger/pusher so that food enters the baby's mouth.
6. Remove the nipple from the baby's mouth once the food has been delivered.
7. Repeat steps 3-6 until finished.

The baby feeder can be made of a variety of materials, but preferably one that is shatter-proof, light-weight, durable, non-toxic, and dishwasher-safe, such as plastic. The size of the baby feeder can also be varied (including the seals) to allow for various amounts of baby food to be dispensed at any given time. Measurements may also be provided on the barrel portion 102 to allow for precise dispensing of baby food.

While the foregoing written description of the invention enables one of ordinary skill in the art to make and use the invention, those of ordinary skill in the art will understand and appreciate the existence of variations, combination, and equivalents of the embodiments, methods, and examples provided herein. The invention should, therefore, not be limited by the embodiments and examples disclosed here, but by all embodiments and methods within the scope and spirit of the invention as claimed.

1. A syringe-type baby feeder comprising:
a barrel having a seal at one end thereof and two opposing finger rings provided on an outside of said barrel;
a plunger sized to fit within said barrel;
said plunger having a pusher portion at one end thereof to move baby food along said barrel;
said plunger having a finger ring formed at the other end thereof;
a nipple piece having a nipple, flange portion and a seal formed between said nipple and said flange portion; and
said seal formed between said nipple and flange portion hermetically sealing to said seal at the one end of said barrel.

2. The syringe-type baby feeder of claim 1, wherein an opening is provided at one end of said nipple to allow baby food to pass therethrough.
